(19) United States
(12) Patent Application Publication
(10) Pub. No.: US 2010/0008283 A1
(43) Pub. Date: Jan. 14, 2010

(54) FRAME STRUCTURES TO SUPPORT MULTICAST COOPERATIVE RELAY SCHEMES

(75) Inventors: Prabhakar R. Chitrapu, Blue Bell, PA (US); Eldad M. Zeira, Huntington, NY (US); Mihaela C. Beluri, Huntington, NY (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL PATENT HOLDINGS, INC., Wilmington, DE (US)

(21) Appl. No.: 12/499,573

(22) Filed: Jul. 8, 2009

Related U.S. Application Data
(60) Provisional application No. 61/079,492, filed on Jul. 10, 2008.

(51) Int. Cl. H04H 20/71

(52) U.S. Cl. 370/312

(57) ABSTRACT

A plurality of time frame structures that support the use of multicast cooperative relay schemes are disclosed. These time frame structures are used in IEEE 802.16j networks as well as other wireless networks. Furthermore, modifications to the frame structures used in IEEE 802.16j networks are disclosed.

### CROSS REFERENCE TO RELATED APPLICATIONS

This application claims the benefit of U.S. Provisional Application No. 61/079,492 filed Jul. 10, 2008, which is incorporated by reference as if fully set forth.

### FIELD OF INVENTION

This application is related to wireless communications.

### BACKGROUND

The use of a relay station (RS) is being investigated for use in cellular and other wireless networks. One approach being investigated is dividing time into segments so that, in the downlink (DL), a base station (BS) transmits data to an RS in one segment and the RS forwards the data to a wireless transmit/receive unit (WTRU) in a second segment. A similar operation also applies for the uplink (UL). The first and second time segments are referred to as phase-1 and phase-2.

The performance of a wireless network can be increased by modifying the approach described above. For example, in phase-1, the BS transmissions towards the RS can also be picked up by the WTRU, which may attempt to soft-decode the transmissions. This is referred to as a multicast relay (MR) scheme. Similarly, in phase-2, the BS can also transmit data to the RS, thereby opening up opportunities for a cooperative transmission.

There are several cooperative transmission techniques possible. The cooperative transmission techniques include spatial diversity transmission, spatial multiplexing, distributed beam-forming, and the like. These techniques are referred to as cooperative relay schemes. The combination of the multicast relay scheme and cooperative transmission techniques results in multicast cooperative relay schemes.

In the Institute of Electrical and Electronics Engineers (IEEE) 802.16j standard, relays are introduced to an IEEE 802.16 wireless metropolitan area network (WMAN). The IEEE 802.16j standard considers the time division duplex (TDD) mode and specifies a frame that is partitioned into DL and UL subframes. These subframes are, in turn, partitioned into access zones and relay zones. In the access zone, the WTRU communicates with the RS and/or the BS in the DL or UL. In the relay zone, the RS communicates with the BS and/or WTRU. The frame structure may apply to DL and/or UL subframes.

The IEEE 802.16j standard introduced the transparent mode and the non-transparent mode, whose key aspects are defined by the frame structures. FIGS. 1 and 2 show exemplary configurations for a conventional transparent relay frame structure. FIG. 3 shows an example of a minimum configuration for a conventional single radio non-transparent relay frame structure. FIG. 4 shows an example of a configuration for a conventional single-radio non-transparent relay frame structure where the MR-BS and RS partition the UL-subframe in the frequency domain.

FIG. 5 shows a conventional IEEE 802.16j transparent frame 500 that is a simplified version of the transparent frame shown in FIG. 1. The simplified IEEE 802.16j transparent frame 500 may be either an MR-BS frame 505 or an RS frame 510. The simplified IEEE 802.16j transparent frame 500 comprises a DL-subframe 520 and a UL-subframe 530. The DL-subframe 520 comprises a DL-access zone (DL-AZ) 535 and an optional transparent zone 540. The UL-subframe 530 comprises an UL-access zone (UL-AZ) 545 and a UL-relay zone (UL-RZ) 550.

For the MR-BS frame 505, the BS transmits data via the DL to the WTRU in the DL-AZ 535, and the BS either transmits data via the DL to the WTRU or remains silent in the optional transparent zone 540. For the RS frame 510, the RS receives the data transmitted via the DL from the BS in the DL-AZ 535, and relays the data to the WTRU in the optional transparent zone 540.

In the first case when the BS remains silent in the optional transparent zone 540, only the RS transmits data via the downlink to the WTRU. Thus, there is no cooperation between the BS and the RS in this case.

In the second case when the BS transmits data via the downlink to the WTRU at the same time as the RS in the optional transparent zone 540, the BS and RS cooperate in phase-2 of the communication to the WTRU.

The simplified IEEE 802.16j transparent frame 500 contains a gap 555 that may include a DL→UL switching time at the end of the DL-subframe 520 for both the MR-BS frame 505 and the RS frame 510.

For the RS frame 510, the WTRU transmits data via the UL to the BS in the UL-AZ 545 and the RS transmits data via the UL to the BS in the UL-RZ 550. Furthermore, for the RS frame 510, the WTRU transmits data via the UL to the RS in the UL-AZ 545 and the RS transmits data via the UL to the BS in the UL-RZ 550. Each of the DL-AZ 535 and the UL-AZ 540 of the RS frame 510 may contain a gap 560 that includes an RS Rx→Tx switching time.

The simplified IEEE 802.16j transparent frame 500 may contain a gap including a UL→DL switching time (not shown) at the end of the UL-subframe 530 for both the MR-BS frame 505 and the RS frame 510.

In a DL-access zone of a transparent frame and a DL-relay zone of a non-transparent frame, the MR-BS transmissions are meant to be received by the RS. However, in both cases the WTRU may also receive the MR-BS transmission. For the non-transparent frame, the WTRU needs to understand the relay-mobile application part (R-MAP). As a result, this may add complexity to the system. This feature is referred to as the multicast aspect of the relaying scheme.

The optional transparent zone of the DL-subframe of the transparent frame supports simultaneous cooperative DL transmissions by the MR-BS as well as the RS. Similarly, the DL-access zone of the DL-subframe of the non-transparent frame supports simultaneous cooperative DL transmissions by the MR-BS as well as the RS. In both cases, the MR-BS and RS transmissions can be space-time coded, spatially multiplexed, coherently beam-formed, or otherwise designed appropriately. This feature is referred to as cooperative transmission.

The combination of the multicast aspect feature and cooperative transmission feature supports multicast cooperative relay schemes. The frame structure according to the IEEE 802.16j standard, in principle, supports multicast cooperative relay schemes. However, the existing frame structures defined in the IEEE 802.16j standard will not work. Accordingly, there exists the need for modifications to the frame structure in the IEEE 802.16j standard.

The IEEE 802.16j standard distinguishes between centralized and distributed scheduling. In centralized scheduling, the BS controls the scheduling. In distributed scheduling, the BS and RS respectively schedule transmissions to/from the RS and WTRU.

In addition to the developments in the IEEE 802.16j standard, there is an ongoing standardization effort in the IEEE 802.16m standard to standardize enhanced relay communication technologies. Currently, there exists the need for time frame structures to support the multicast cooperative relay schemes disclosed in IEEE 802.16j networks, as well as other wireless networks. Furthermore, there exists the need for modifications to the frame structures used in IEEE 802.16j networks.

### SUMMARY

A plurality of time frame structures that support the use of multicast cooperative relay schemes are disclosed. These time frame structures are used in IEEE 802.16j networks as well as other wireless networks. Furthermore, modifications to the frame structures used in IEEE 802.16j networks are disclosed.

### BRIEF DESCRIPTION OF THE DRAWINGS

A more detailed understanding may be had from the following description, given by way of example in conjunction with the accompanying drawings wherein:

FIGS. 1 and 2 show exemplary configurations for a conventional transparent relay frame structure;

FIG. 3 shows an example of a minimum configuration for a conventional single radio non-transparent relay frame structure;

FIG. 4 shows an example of a configuration for a conventional single-radio non-transparent relay frame structure where the MR-BS and RS partition the UL-subframe in the frequency domain;

FIG. 5 shows a conventional IEEE 802.16j transparent frame that is a simplified version of the transparent frame shown in FIG. 1;

FIG. 6 shows a modified IEEE 802.16j transparent frame for DL cooperation;

FIG. 7 shows a modified IEEE 802.16j transparent frame for UL cooperation;

FIG. 8 shows an example data flow using modified IEEE 802.16j transparent frames;

FIG. 9 shows a simplified IEEE 802.16j non-transparent frame structure;

FIG. 10 shows a modified IEEE 802.16 non-transparent frame structure for use in IEEE 802.16m;

FIG. 11 shows an example data flow using modified IEEE 802.16j non-transparent frames;

FIG. 12 shows multicast cooperation using a two-hop time separated frame structure;

FIG. 13 shows multicast cooperation using a three-hop time separated frame structure;

FIG. 14 shows an RS communicating with a WTRU;

FIG. 15 shows a WTRU communicating with a BS; and

FIG. 16 shows an RS communicating with a BS.

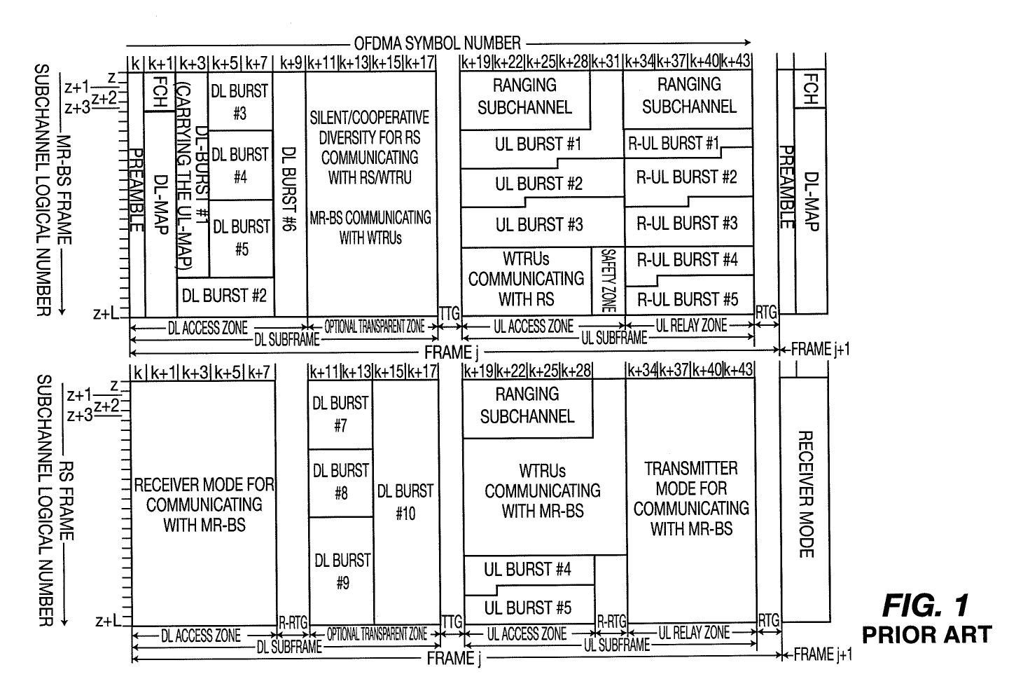

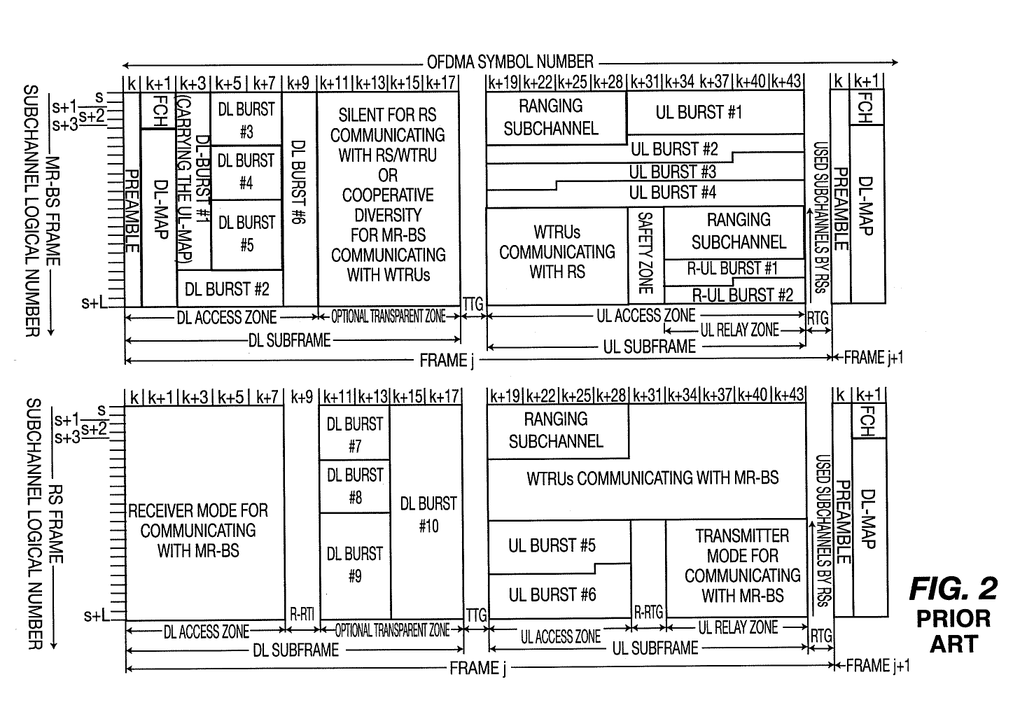

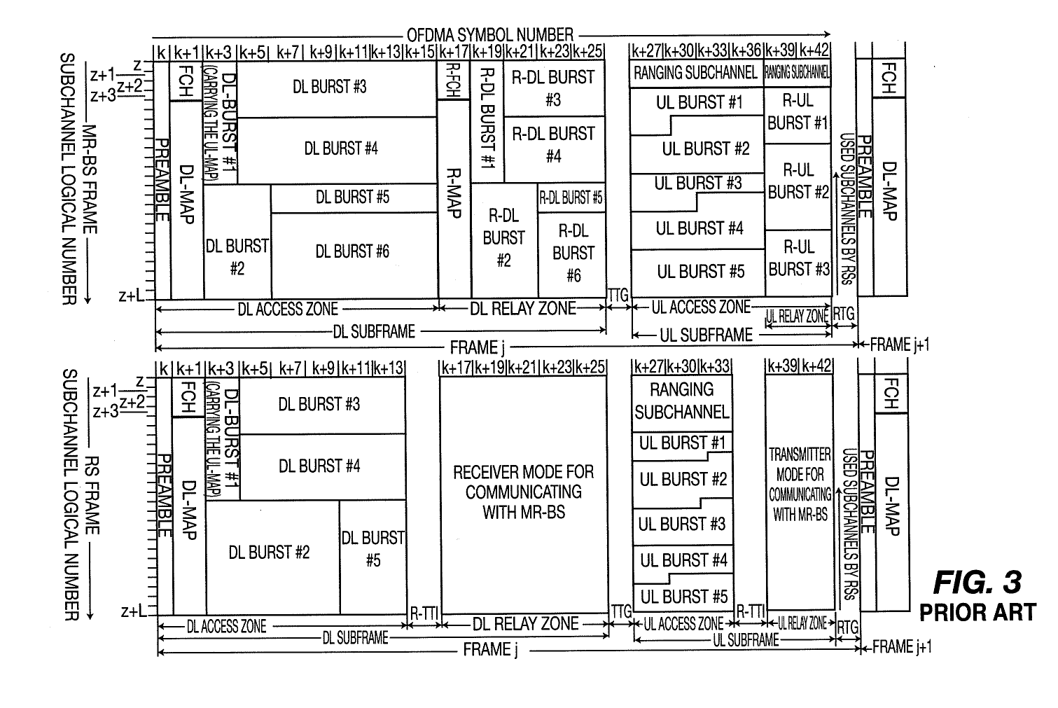

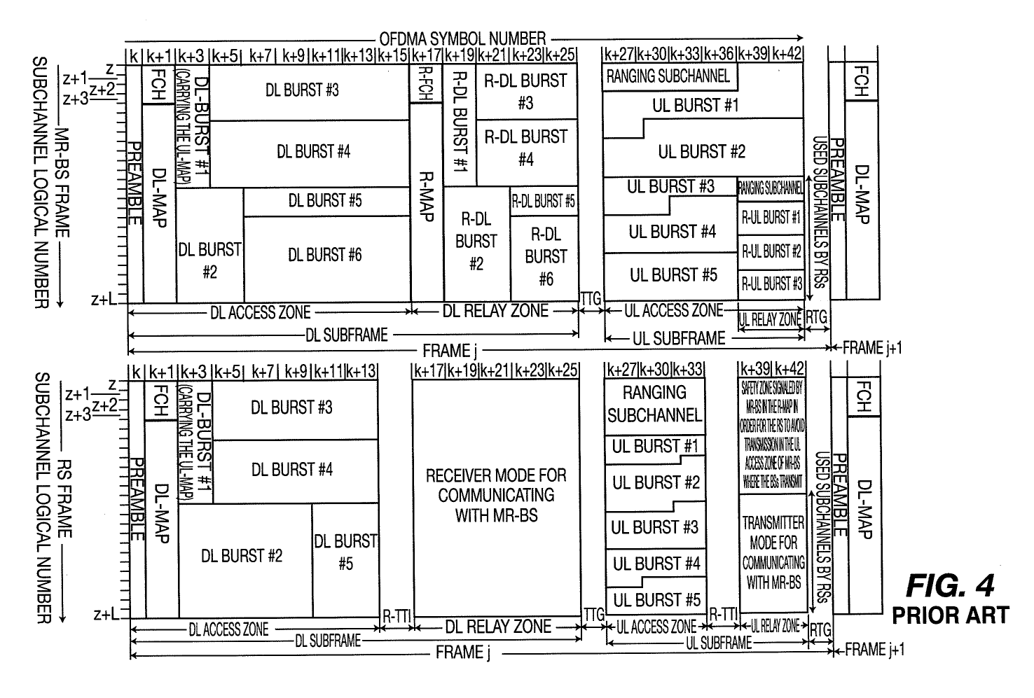

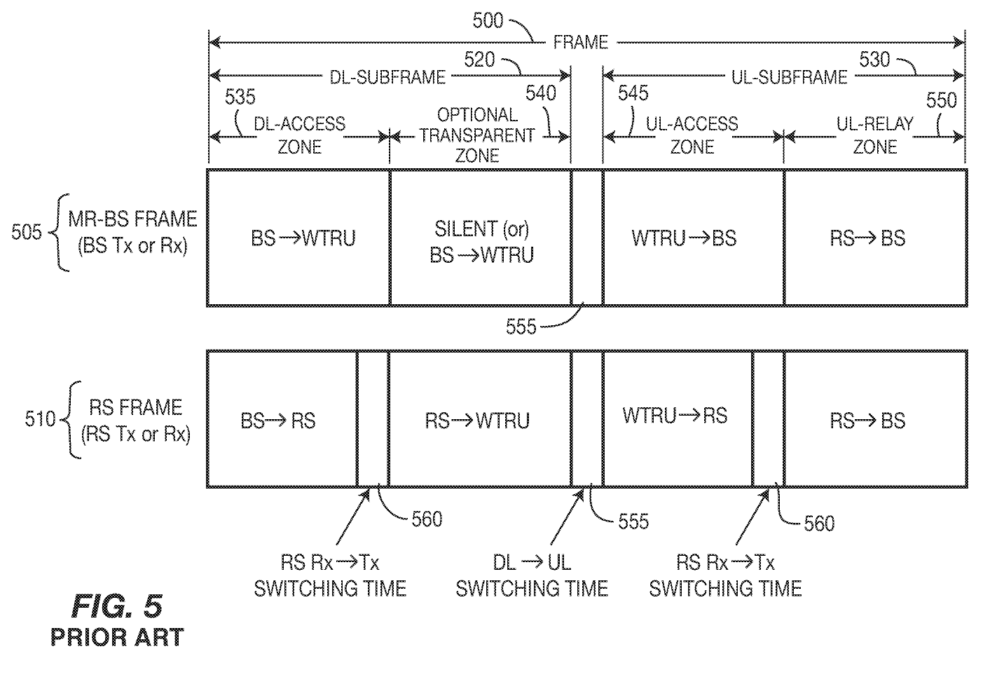

### DETAILED DESCRIPTION

When referred to hereafter, the terminology “wireless transmit/receive unit (WTRU)” includes but is not limited to a user equipment (UE), a mobile station, a fixed or mobile subscriber unit, a pager, a cellular telephone, a personal digital assistant (PDA), a computer, or any other type of user device capable of operating in a wireless environment.

When referred to hereafter, the terminology “base station” includes but is not limited to a Node-B, a site controller, an access point (AP), or any other type of interfacing device capable of operating in a wireless environment.

A plurality of time frame structures that support the use of multicast cooperative relay schemes are disclosed. To support multicast cooperative relay schemes, the existing IEEE 802.16j frame structure may be modified for use in an IEEE 802.16m network.

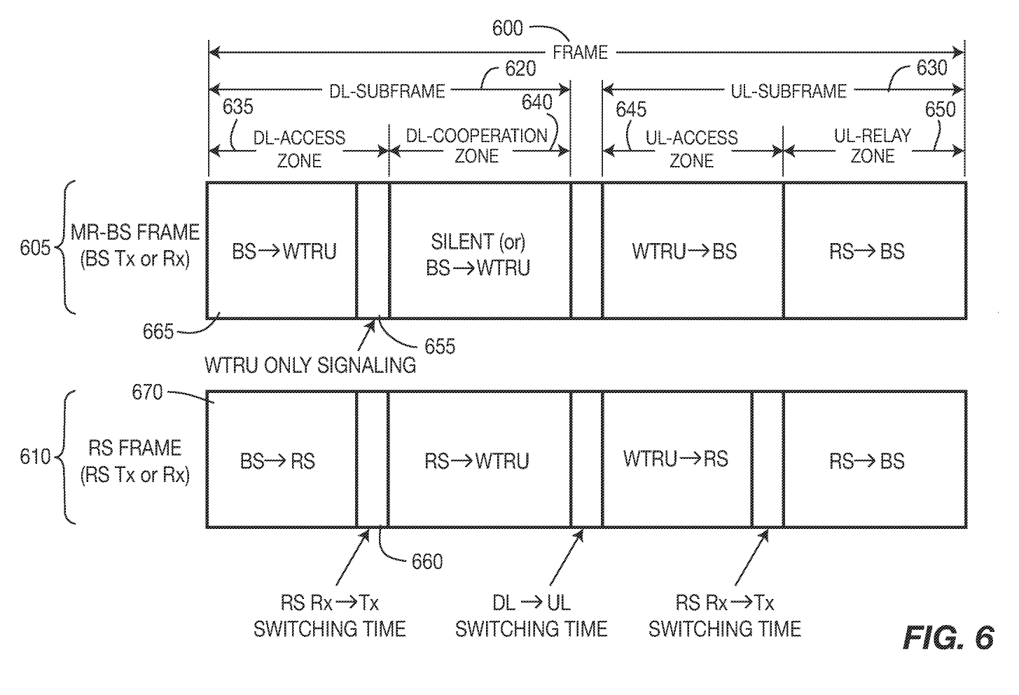

FIG. 6 shows a modified IEEE 802.16j transparent frame 600 for DL cooperation. The modified IEEE 802.16j transparent frame 600 may be either an MR-BS frame 605 or an RS frame 610. The simplified IEEE 802.16j transparent frame 600 comprises a DL-subframe 620 and a UL-subframe 630. The DL-subframe 620 comprises a DL-AZ 635 and a DL cooperation zone (DL-CZ) 640. The UL-subframe 630 comprises an UL-AZ 645 and a UL-RZ 650.

For the MR-BS frame 605, the BS transmits data via the DL to the WTRU in portion 665 of the DL-AZ 635, and the BS either transmits data via the DL to the WTRU or remains silent in the DL-CZ 640. For the RS frame 610, the RS receives the data transmitted via the DL from the BS in portion 670 of the DL-AZ 635, and relays the data to the WTRU in the DL-CZ 640.

In the first case when the BS remains silent in the DL-CZ 640, only the RS transmits data via the downlink to the WTRU. Thus, there is no cooperation between the BS and the RS in this case.

In the second case when the BS transmits data via the downlink to the WTRU at the same time as the RS in the DL-CZ 640, the BS and RS cooperate in phase-2 of the communication to the WTRU.

The modified IEEE 802.16j transparent frame 600 contains a gap 655 in the DL-AZ 635 of the MR-BS frame 605. This gap 655 corresponds to the gap 660 in the DL-AZ 635 of the RS frame 610. During the gap 655, the BS may transmit only to WTRUs directly attached to it, (i.e., “WTRU only signaling”). The BS does not transmit data for the RS, or for WTRUs attached to the RS. Thus, no transmissions are made to the RS or to the WTRUs attached to the RS. The gap 655 enables a multicast mode of cooperation. More specifically, during the DL-AZ 635, the BS transmits data to the RS, and the WTRUs attached to the RS “listen” to the BS transmission. The soft information received by the WTRU during the DL-AZ 635 may be combined with the information subsequently transmitted by the RS during the DCZ 640.

The gap 655 may be used to send WTRU-only signaling. The gap 655 is an important feature of the modified IEEE 802.16j transparent frame 600 because it enables the RS and WTRUs attached to the RS to receive the same information transmitted by the BS. This enables the WTRU to combine the soft bits received from the BS during the DL-AZ 635 with the soft bits re-transmitted by the RS during the DL-CZ 640. In the absence of the gap 655, the message lengths received by the RS and the WTRU attached to the RS would be different, which would impact the ability of the WTRU to combine the soft information received during the DL-AZ 635 with the one received during the DL-CZ 640.

Thus, a DL-subframe 620 is generated that supports simultaneous cooperative DL transmissions. The DL-AZ 635 is generated, wherein a first portion 670 of the DL-AZ 635 allows a BS to transmit data to be relayed by an RS, and a second portion of the DL-AZ 635 (gap 655) allows the BS to transmit data that is not to be relayed by the RS. The DL-CZ 640 is also generated, which allows the BS and the RS to simultaneously transmit data.

The data that is not relayed by the RS may include control information for a WTRU, (e.g., power setting information, scheduling information, discontinuous transmission (DTX) information, discontinuous reception (DRX) information, and the like). The second portion of the DL-AZ 635 (gap 655) enables a multicast mode of cooperation during a period of time (gap 660) when the RS switches from receiving (Rx) to transmitting (Tx). During the DL-CZ 640, the RS relays to a WTRU the data transmitted by the BS during the first portion of the DL-AZ 635.

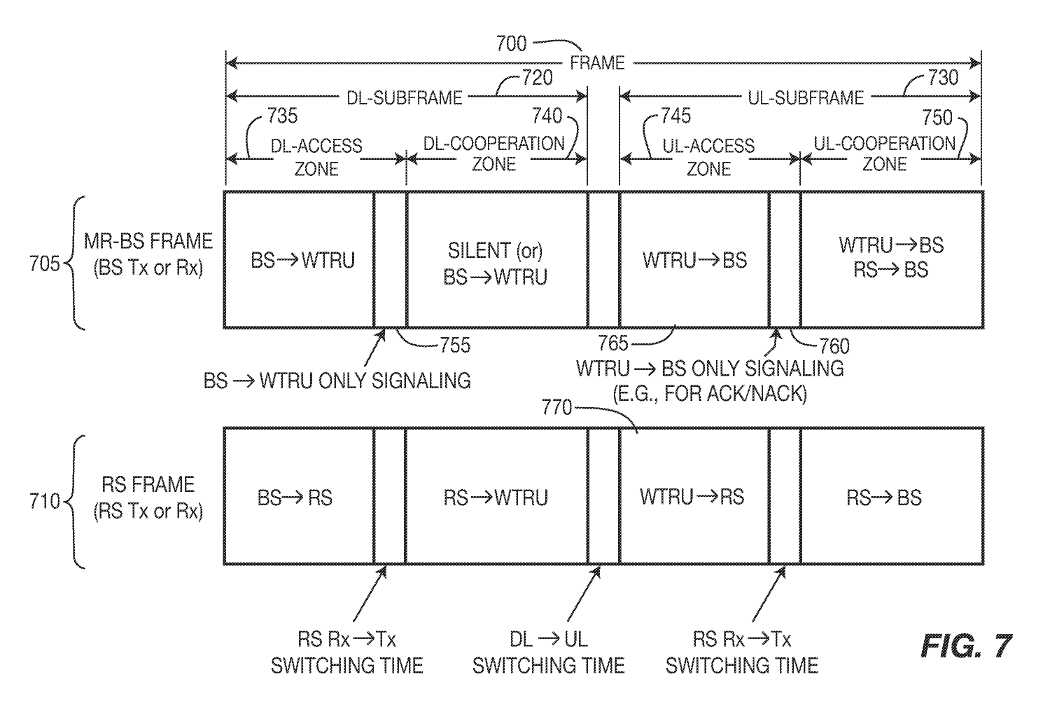

FIG. 7 shows a modified IEEE 802.16j transparent frame 700 for UL cooperation. The modified IEEE 802.16j transparent frame 700 may be either an MR-BS frame 705 or an RS frame 710. The simplified IEEE 802.16j transparent frame 700 comprises a DL-subframe 720 and a UL-subframe 730. The DL-subframe 720 comprises a DL-AZ 735 and a DL-CZ 740. The UL-subframe 730 comprises an UL-AZ 745 and a UL-CZ 750.

The DL-CZ 740 in the DL-subframe 720 allows cooperation between the BS and RS when transmitting data in the downlink to the WTRU, in hop2 (or phase-2) of the communication. The UL-CZ 750 in the UL-subframe 730 allows cooperation between the BS and RS when transmitting data in the uplink to the BS, in hop-2 (or phase-2) of the communication. Thus, the WRTU and the RS may transmit in a coordinated fashion the same information bits to the BS. For example, since both the RS and the WRTU have the same information bits, they can perform either distributed transmit diversity, (e.g., space-frequency block coding (SFBC)), if using the same redundancy version and modulation coding scheme (MCS), or distributed spatial multiplexing, if using different redundancy versions and MCS.

The gap 755 labeled “BS→WTRU only signaling” in the DL-AZ 735 is different from the rest of the DL-AZ 735 in that the BS only transmits to the WTRUs directly attached to the BS, and does not transmit to the RS, or the WTRUs attached to the RS. The gap 760 in the UL-AZ 745 is different from the rest of the UL-AZ 745 (portions 765 and 770). Due to the fact that the RS needs to switch from receiving in UL to transmitting in UL, the BS cannot receive data from a WTRU during the gap 760. To enable the BS to “listen” to WTRUs attached to the RS, the WTRU transmission to the RS needs to be only as long as the UL-AZ 745 of the RS frame 710. During the gap 760, only WTRUs attached to the BS may still transmit to the BS via the UL.

In the DL-CZ 740 in the DL-subframe 720, the RS and possibly the BS communicate with the WTRU. In the UL-CZ 750 of the UL-subframe 730, both the WTRU and the RS may communicate with the BS, (e.g., for acknowledgments/non-acknowledgments).

Thus, a UL-subframe 730 is generated that supports simultaneous cooperative UL transmissions. The UL-AZ 745 is generated, wherein a first portion 770 of the UL-AZ 745 allows a WTRU to transmit data to be relayed by an RS, and a second portion of the UL-AZ 735 (gap 760) allows the WTRU to transmit data that is not to be relayed by the RS. The UL-CZ 750 is also generated, which allows the WTRU and the RS to simultaneously transmit data.

The data that is not relayed by the RS may include feedback information (e.g., ACK/NACK) for a BS. The second portion of the UL-AZ 745 (gap 655) enables a multicast mode of cooperation during a period of time when the RS switches from receiving (Rx) to transmitting (Tx). During the UL-CZ 750, the RS relays to a BS the data transmitted by the WTRU during the first portion of the UL-AZ 745.

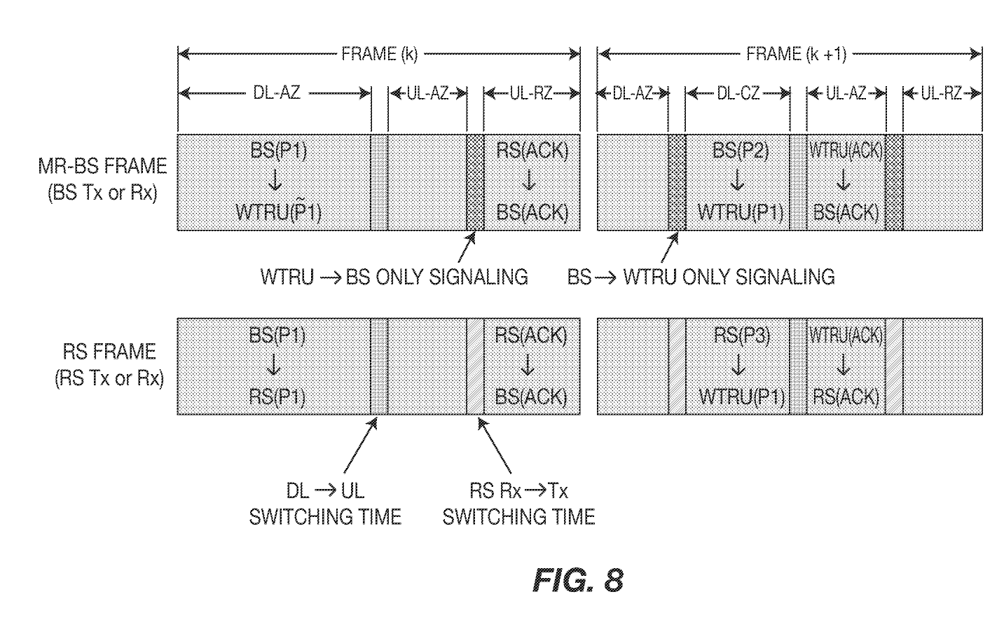

FIG. 8 shows an example data flow using modified IEEE 802.16j transparent frames. FIG. 8 shows the frame structures described above performing DL data communications using transparent cooperative schemes.

To enable cooperation during phase-2, (either distributed space time block coding (STBC)/space frequency block coding (SFBC) or distributed spatial multiplexing), the WTRU needs to perform channel estimation for both the BS WTRU link and the RS⇄WTRU link. Accordingly, the WTRU needs to be aware of the presence of the RS so that the RS can be non-transparent from this stand-point. This allows the RS to transmit control information to support various cooperation schemes. For example, the RS may signal the redundancy version (RV) and the modulation and coding scheme (MCS), which can potentially be different from the RV and MCS used by the BS in phase-2, even when BS and RS are using the same physical resources for the transmission.

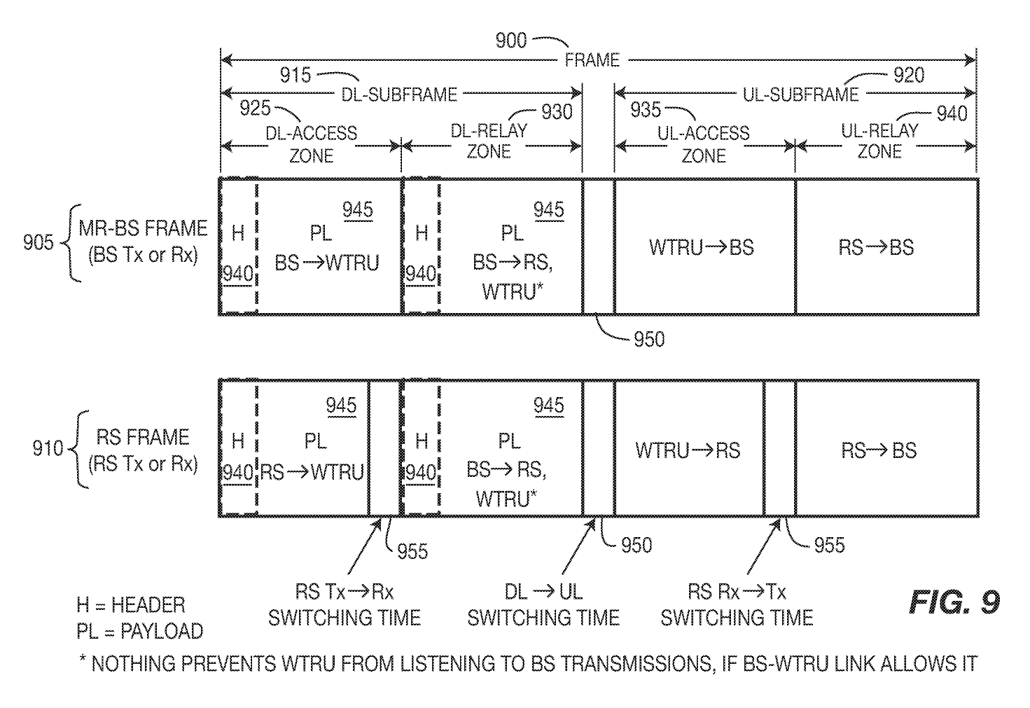

FIG. 9 shows a simplified IEEE 802.16j non-transparent frame structure 900. The simplified IEEE 802.16j non-transparent frame 900 may be either an MR-BS frame 905 or an RS frame 910. The simplified IEEE 802.16j non-transparent frame 900 comprises a DL-subframe 915 and a UL-subframe 920. The DL-subframe 915 comprises a DL-AZ 925 and a DL-RZ 930. Each of the DL-AZ 925 and the DL-RZ 930 contain a payload (PL) 945 and a header (H) 940. The UL-subframe 920 comprises a UL-AZ 935 and a UL-RZ 940.

For the MR-BS frame 905, the BS communicates with the WTRU in the DL-AZ 925 and the BS communicates with the RS in the DL-RZ 930. In the DL-RZ 930, the WTRU may listen to BS transmissions so long as the BS⇄WTRU link permits the WTRU to listen. For the RS frame 910, the RS communicates with the WTRU in the DL-AZ 925 and the BS communicates with the RS in the DL-RZ 930. In the DL-RZ 930, the WTRU may listen to BS transmissions so long as the BS⇄WTRU link permits the WTRU to listen.

The simplified IEEE 802.16j non-transparent frame 900 contains a gap 950 that may include a DL→UL switching time at the end of the DL-subframe 915 for both the MR-BS frame 905 and the RS frame 910.

For the RS frame 910, the WTRU communicates with the BS in the UL-AZ 935 and the RS communicates with BS in the UL-RZ 940. For the RS frame 910, the WTRU communicates with the RS in the UL-AZ 935 and the RS communicates with the BS in the UL-RZ 940. Each of the DL-AZ 925 and the UL-AZ 935 of the RS frame 910 contains a gap 950 that may include an RS Rx→Tx switching time.

The simplified IEEE 802.16j transparent frame 900 may contain a gap (not shown) that may include a UL→DL switching time at the end of the UL-subframe 920 for both MR-BS frame 905 and the RS frame 910.

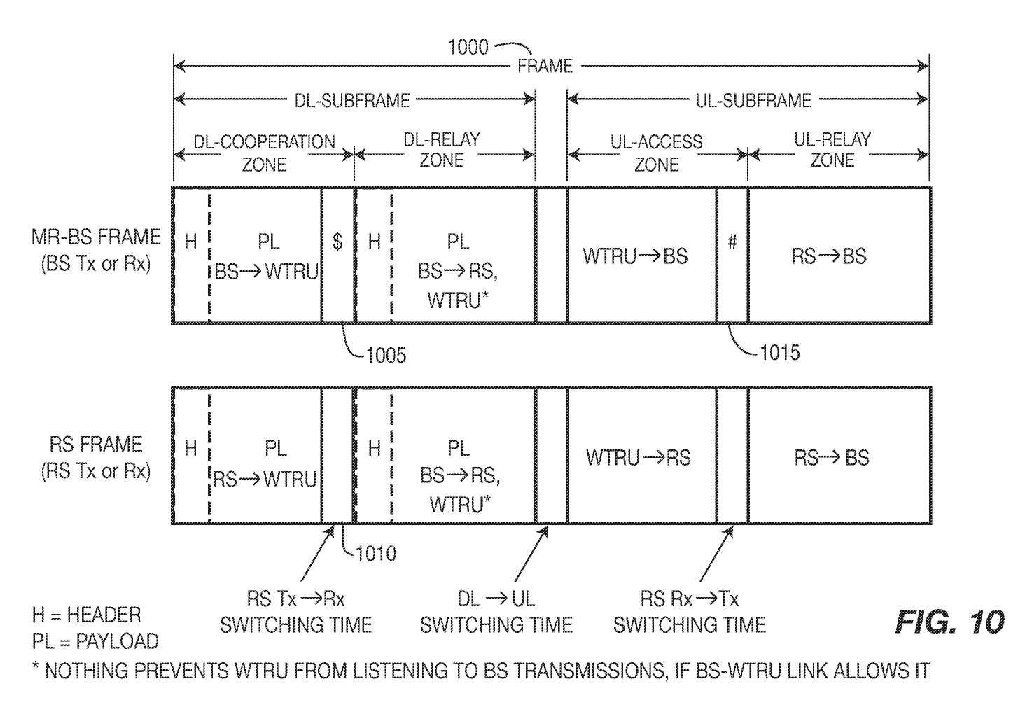

FIG. 10 shows a modified IEEE 802.16j non-transparent frame structure 1000 for use in IEEE 802.16m. This modified IEEE 802.16j frame structure 1000 allows for multicast in phase-1 because nothing prevents the WTRU from listening to BS transmission in the DL-RZ so long as the BS⇄WTRU link permits the WTRU to listen. The modified IEEE 802.16j non-transparent frame 1000 contains a gap 1005 in a DL-CZ of the MR-BS frame. This gap 1005 corresponds to a gap 1010 in the DL-CZ of the RS frame. The gap 1005 in the DL-CZ of the MR-BS frame is either silent or contains transmissions from the RS meant for the WTRU. As a result, this enables distributed cooperative multiplexing/diversity in phase-2. The modified IEEE 802.16j non-transparent frame 1000 also contains a gap 1015 in the UL-AZ of the MR-BS frame. In the gap 1015 in the UL-AZ, the WTRU is either silent or transmits data meant for the BS.

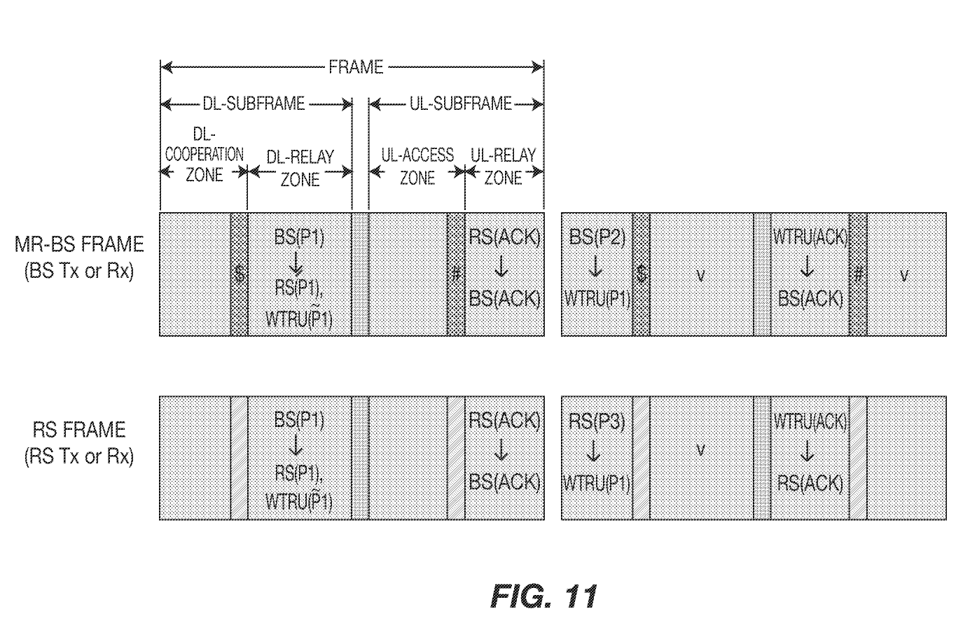

FIG. 11 shows an example data flow using modified IEEE 802.16j non-transparent frames.

There are several proposed IEEE 802.16m frame structures that support multi-hop relays. The multicast cooperation scheme may be implemented in the framework of time-separated frame structure known in the art.

In the DL-RZ of the DL-subframe, an IEEE 802.16m BS transmits to subordinate IEEE 802.16m RSs and an IEEE 802.16m WTRU directly attached to the BS. For odd-hop RS behavior, the IEEE 802.16m RS receives from its super-ordinate station. For even-hop RS behavior, the IEEE 802.16m RS transmits to subordinate IEEE 802.16m RSs and/or WTRUs directly attached to the current RS. Furthermore, in the DL-RZ of the DL-subframe, an IEEE 802.16m WTRU attached to an odd-hop RS listens to a transmission from the BS wherein the WTRU is attached to a first-hop RS or listens to a super-ordinate RS wherein the WTRU is attached to a third-hop RS.

In the DL-AZ of the DL-subframe, an IEEE 802.16m BS transmits to an IEEE 802.16 WTRU directly attached to the BS and/or to a WTRU directly attached to the first-hop RS. For odd-hop RS behavior, the IEEE 802.16m RS transmits to subordinate IEEE 802.16m RSs and/or to WTRUs directly attached to the current RS. For even-hop RS behavior, the IEEE 802.16m RS receives from its super-ordinate station. Further, in the DL-AZ of the DL-subframe, an IEEE 802.16m WTRU receives data from the RS to which it is attached and from its super-ordinate station.

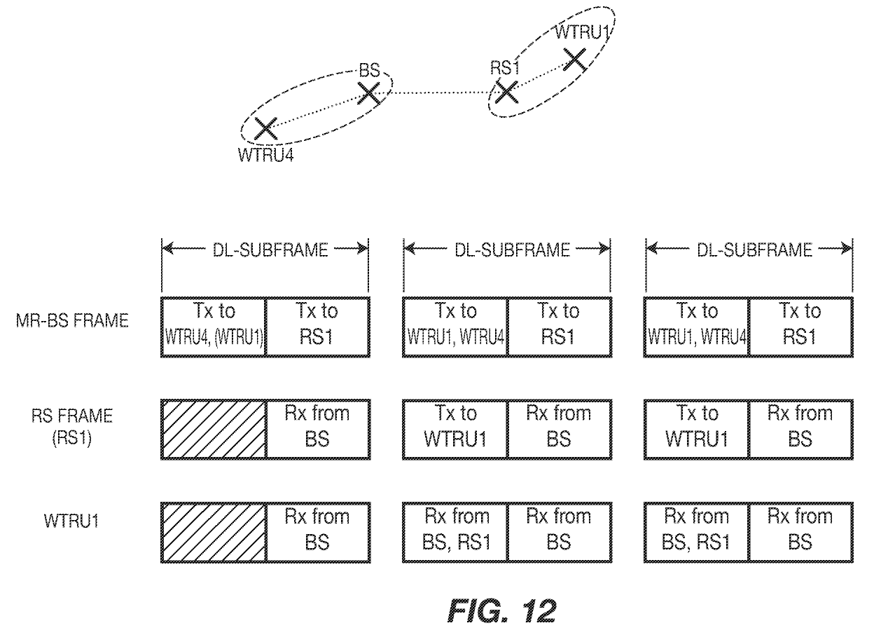

FIG. 12 shows multicast cooperation using a two-hop time separated frame structure. Please note that only the DL-subframes are shown. Further, please note that WTRU1 is attached to RS1, and WTRU4 is directly attached to the BS.

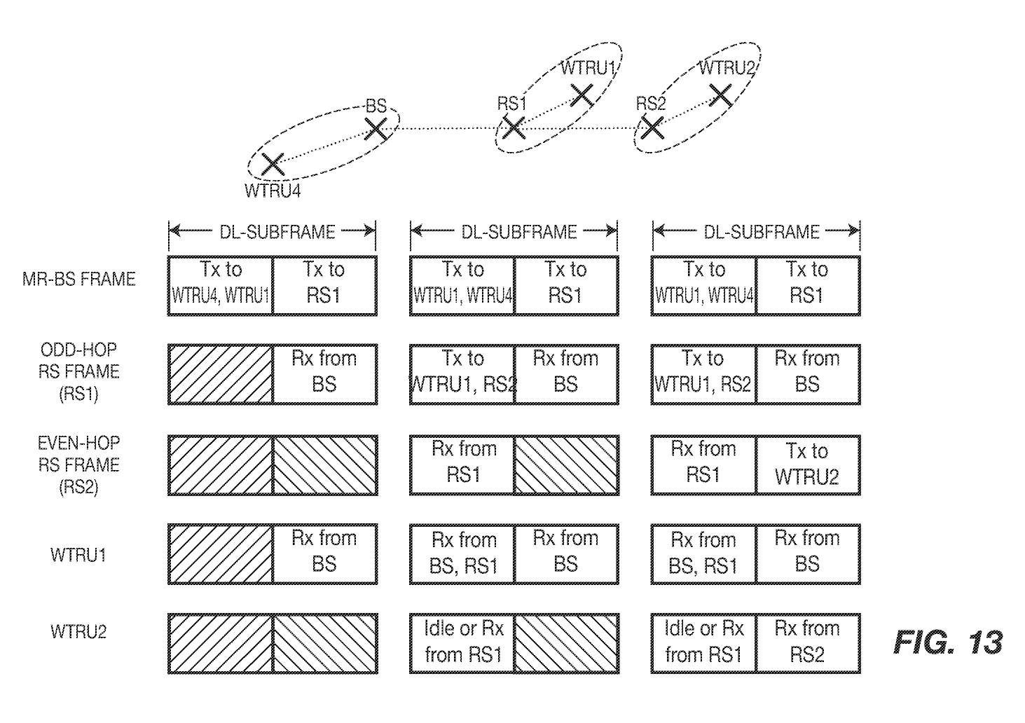

FIG. 13 shows multicast cooperation using a three-hop time separated frame structure. Please note that WTRU2 is attached to RS2, WTRU1 is attached to RS1, and WTRU4 is directly attached to the BS.

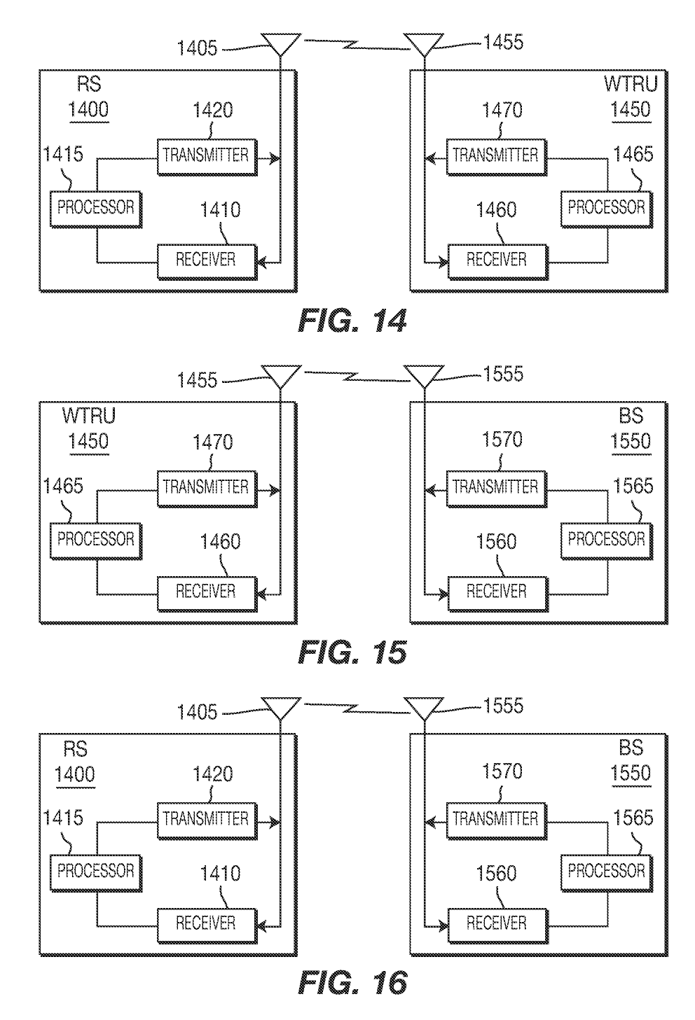

FIG. 14 shows an RS 1400 communicating with a WTRU 1450. The RS 1400 includes an antenna 1405, (e.g., a MIMO antenna), a receiver 1410, a processor 1415 and a transmitter 1420. The WTRU 1450 includes an antenna 1455, (e.g., a MIMO antenna), a receiver 1460, a processor 1465 and a transmitter 1470.

FIG. 15 shows the WTRU 1450 communicating with a BS 1550. The BS 1550 includes an antenna 1555, (e.g., a MIMO antenna), a receiver 1560, a processor 1565 and a transmitter 1570.

FIG. 16 shows the RS 1400 communicating with the BS 1550.

Referring to FIGS. 14-16, a wireless communication apparatus for generating a DL subframe that supports simultaneous cooperative DL transmissions may comprise the RS 1400 and the BS 1550. A first portion of a DL-AZ allows the BS 1550 to transmit data to be relayed by the RS 1400, a second portion of the DL-AZ allows the BS 1550 to transmit data that is not to be relayed by the RS 1400, and a DL-CZ allows the BS 1500 and the RS 1400 to simultaneously transmit data.

The data that is not relayed by the RS 1400 may include control information for a WTRU, (e.g., power setting information, scheduling information, DTX information, DRX information, and the like). The second portion of the DL-AZ enables a multicast mode of cooperation during a period of time when the RS 1400 switches from Rx to Tx. During the DL-CZ, the RS 1400 relays to a WTRU 1405 the data transmitted by the BS 1550 during the first portion of the DL-AZ.

Still referring to FIGS. 14-16, a wireless communication apparatus for generating a UL subframe that supports simultaneous cooperative UL transmissions may comprise the WTRU 1450 and the RS 1400. A first portion of a UL-AZ allows the WTRU 1450 to transmit data to be relayed by the RS 1400, a second portion of the UL-AZ allows the WTRU 1450 to transmit data that is not to be relayed by the RS 1400, and a UL-CZ allows the WTRU 1450 and the RS 1400 to simultaneously transmit data.

The data that is not relayed by the RS 1400 may include feedback information for a BS. The second portion of the UL-AZ enables a multicast mode of cooperation during a period of time when the RS 1400 switches from Rx to Tx. During the UL-CZ, the RS 1400 relays to a BS 1550 the data transmitted by the WTRU 1455 during the first portion of the UL-AZ.

Although features and elements are described above in particular combinations, each feature or element can be used alone without the other features and elements or in various combinations with or without other features and elements. The methods or flow charts provided herein may be implemented in a computer program, software, or firmware incorporated in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (UE), terminal, base station, radio network controller (RNC), or any host computer. The WTRU may be used in conjunction with modules, implemented in hardware and/or software, such as a camera, a video camera module, a videophone, a speakerphone, a vibration device, a speaker, a microphone, a television transceiver, a hands free headset, a keyboard, a Bluetooth® module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) or Ultra Wide Band (UWB) module.

What is claimed is:

1. A method of generating a downlink (DL) subframe that supports simultaneous cooperative DL transmissions, the method comprising:
generating a DL-access zone (DL-AZ), wherein a first portion of the DL-AZ allows a base station (BS) to transmit data to be relayed by a relay station (RS), and a second portion of the DL-AZ allows the BS to transmit data that is not to be relayed by the RS; and
generating a DL-cooperative zone (DL-CZ) that allows the BS and the RS to simultaneously transmit data.

2. The method of claim 1 wherein the data that is not relayed by the RS includes power setting information for a wireless transmit/receive unit (WTRU).

3. The method of claim 1 wherein the data that is not relayed by the RS includes scheduling information for a wireless transmit/receive unit (WTRU).

4. The method of claim 1 wherein the data that is not relayed by the RS includes discontinuous transmission (DTX) information for a wireless transmit/receive unit (WTRU).

5. The method of claim 1 wherein the data that is not relayed by the RS includes discontinuous reception (DRX) information for a wireless transmit/receive unit (WTRU).

6. The method of claim 1 wherein the second portion of the DL-AZ enables a multicast mode of cooperation during a period of time when the RS switches from receiving to transmitting.

7. The method of claim 1 wherein, during the DL-CZ, the RS relays to a wireless transmit/receive unit (WTRU) the data transmitted by the BS during the first portion of the DL-AZ.

8. The method of claim 1 wherein the DL subframe is comprised by an IEEE 802.16j transparent frame.

9. A method of generating an uplink (UL) subframe that supports simultaneous cooperative UL transmissions, the method comprising:
generating a UL-access zone (UL-AZ), wherein a first portion of the UL-AZ allows a wireless transmit/receive unit (WTRU) to transmit data to be relayed by a relay station (RS), and a second portion of the UL-AZ allows the WTRU to transmit data that is not to be relayed by the RS; and
generating a UL-cooperative zone (UL-CZ) that allows the WTRU and the RS to simultaneously transmit data.

10. The method of claim 9 wherein the data that is not relayed by the RS includes feedback information for a base station (BS).

11. The method of claim 9 wherein the second portion of the UL-AZ enables a multicast mode of cooperation during a period of time when the RS switches from receiving to transmitting.

12. The method of claim 9 wherein, during the UL-CZ, the RS relays to a base station (BS) the data transmitted by the WTRU during the first portion of the UL-AZ.

13. The method of claim 9 wherein the UL subframe is comprised by an IEEE 802.16j transparent frame.

14. Wireless communication apparatus for generating a downlink (DL) subframe that supports simultaneous cooperative DL transmissions, the apparatus comprising:
a relay station (RS); and
a base station (BS), wherein a first portion of a DL-access zone (DL-AZ) allows the BS to transmit data to be relayed by the RS, a second portion of the DL-AZ allows the BS to transmit data that is not to be relayed by the RS, and a DL-cooperative zone (DL-CZ) allows the BS and the RS to simultaneously transmit data.

15. The apparatus of claim 14 wherein the data that is not relayed by the RS includes power setting information for a wireless transmit/receive unit (WTRU).

16. The apparatus of claim 14 wherein the data that is not relayed by the RS includes scheduling information for a wireless transmit/receive unit (WTRU).

17. The apparatus of claim 14 wherein the data that is not relayed by the RS includes discontinuous transmission (DTX) information for a wireless transmit/receive unit (WTRU).

18. The apparatus of claim 14 wherein the data that is not relayed by the RS includes discontinuous reception (DRX) information for a wireless transmit/receive unit (WTRU).

19. The apparatus of claim 14 wherein the second portion of the DL-AZ enables a multicast mode of cooperation during a period of time when the RS switches from receiving to transmitting.

20. The apparatus of claim 14 wherein, during the DL-CZ, the RS relays to a wireless transmit/receive unit (WTRU) the data transmitted by the BS during the first portion of the DL-AZ.

21. The apparatus of claim 14 wherein the DL subframe is comprised by an IEEE 802.16j transparent frame.

22. Wireless communication apparatus for generating an uplink (UL) subframe that supports simultaneous cooperative UL transmissions, the apparatus comprising:
a wireless transmit/receive unit (WTRU); and
a relay station (RS), wherein a first portion of a UL-access zone (UL-AZ) allows the WTRU to transmit data to be relayed by the RS, a second portion of the UL-AZ allows the WTRU to transmit data that is not to be relayed by the RS, and a UL-cooperative zone (UL-CZ) allows the WTRU and the RS to simultaneously transmit data.

23. The apparatus of claim 22 wherein the data that is not relayed by the RS includes feedback information for a base station (BS).

24. The apparatus of claim 22 wherein the second portion of the UL-AZ enables a multicast mode of cooperation during a period of time when the RS switches from receiving to transmitting.

25. The apparatus of claim 22 wherein, during the UL-CZ, the RS relays to a base station (BS) the data transmitted by the WTRU during the first portion of the UL-AZ.

26. The apparatus of claim 22 wherein the UL subframe is comprised by an IEEE 802.16j transparent frame.
